(19) United States
(12) Patent Application Publication
(10) Pub. No.: US 2004/0230682 A1
(43) Pub. Date: Nov. 18, 2004

(54) Handling queued sessions

(76) Inventor: Pekka Salomo Immonen, Lepsama (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/477,415

(22) PCT Filed: May 8, 2002
(86) PCT No.: PCT/IB02/02522

(30) Foreign Application Priority Data
May 14, 2001 (GB) 0111757.1

(51) Int. Cl. G06F 15/16

(52) U.S. Cl. 709/227

(57) ABSTRACT

A method for providing a terminal with a service from a service centre, the terminal and the service centre being connected by a communication network, the method comprising: transmitting from the terminal to the service centre a request for the service; adding the terminal to a queue for the service; transmitting to the terminal by a first form of connection one or more indications of the status of the terminal in the queue; determining that the service centre is ready to provide the terminal with the service; establishing a session between the terminal and the service centre using a second form of connection having greater network demands than the first form of connection; and providing the terminal with the service using the session.

This invention relates to handling of queued sessions in a communications system.

Communication systems frequently provide for a user of the system to access a service by means of a session supported by the communications system. One example of this is a directory enquiry service. In a directory enquiry service, a user can query a directory of phone numbers by means of a communication session with a directory enquiry agent. It may happen that demand for the service exceeds supply. In that situation, requests for sessions with the service are queued, and the queued requests are served in a predetermined order—normally in order of joining the queue.

As an illustration, the following examples take the situation of a user who wishes to speak to a directory enquiry service.

In one arrangement, the user calls the directory enquiry service and a voice communication link is established between the user's terminal and a control centre for the directory enquiry service. If no directory enquiry agents are available then the control centre transmits an audible message to the user over the voice link to inform the user that he is held in a queue. The message generated by the control centre may give the user an estimate of the length of the queue. When an agent is free the control centre routes the voice link to that agent's terminal so that the user can speak to the agent and use the directory enquiry service. In networks in which bandwidth is severely limited, for example mobile telephone networks, this arrangement has a severe drawback. Since the communication link is enabled for voice for the entire duration of the call—even when the user is queued and not able to speak to the agent—the call may waste a great deal of bandwidth.

The GSM (Global System for Mobile Communications) mobile telephone system provides a means to alleviate the above drawback. In the GSM system there is an arrangement whereby when the user (the A-subscriber in GSM terminology) calls the directory enquiry service (the B-subscriber) and the B-subscriber is busy, no call is set up. Instead, the request for a call is queued at the network until the B-subscriber is free; i.e. when an agent is available to serve the user. Then the call is set up. In this way, the use of network resources is greatly reduced. However, since the call is not set up until the B-subscriber is free (when the user has reached the front of the queue), up to that stage the B-subscriber is unable to inform the user how long he will be kept in the queue.

As customers become more demanding, there is an increasing need to limit the bandwidth used by a call until it reaches the front of the queue, but also to provide users with an indication of their expected wait in the queue.

According to one aspect of the present invention, there is provided a method for providing a terminal with a service from a service centre, the terminal and the service centre being connected by a communication network, the method comprising: transmitting from the terminal to the service centre a request for the service; adding the terminal to a queue for the service; transmitting to the terminal by a first form of connection one or more indications of the status of the terminal in the queue; determining that the service centre is ready to provide the terminal with the service; establishing a session between the terminal and the service centre using a second form of connection having greater network demands than the first form of connection; and providing the terminal with the service using the session.

According to one aspect of the present invention, there is provided a service provision system for providing a terminal with a service from a service centre, the terminal and the service centre being connected by a communication network, the service centre comprising: a messaging arrangement capable of communicating with the terminal by means of a messaging protocol; an indication server capable of transmitting to the terminal by a first form of connection one or more indications of the status of the terminal in a queue; a data store for storing information defining the status of one or more terminals in a queue for the service; and an agent capable of providing the service to the terminal using a session between the terminal and the service centre using a second form of connection having greater network demands than the first form of connection; and wherein the messaging arrangement is arranged to, in response to a request for the service from the terminal by means of the messaging protocol the for the service, determine whether the service centre is ready to provide the service and if it is not ready to provide the service to terminal a message indicating that it should request from the indication server an indication of the status of the terminal in the queue.

Preferably the method includes the steps of: receiving the request; and determining whether the service centre is ready to provide the terminal with the service; and the steps of adding the terminal to a queue for the service and transmitting to the terminal by a first form of connection one or more indications of the status of the terminal in the queue are performed only if it is determined that the service centre is not ready to provide the terminal with the service.

Preferably the request for the service is transmitted in a packet format. The request for the service may most preferably be transmitted in SIP format.

The method suitably comprises the steps of: transmitting to the terminal an indication of the address of an indication server from which the one or more indications of the status of the terminal in the queue may be received; and transmitting from the terminal to the said address a request for the one or more indications.

The indication of the address of the indication server may be transmitted in a packet and/or SIP format.

The request for the one or more indications may be transmitted in packet and/or HTTP format.

The said one or more indications may include data in HTML format and/or an applet for execution at the terminal. The method suitably includes the step of executing the applet.

The method may comprise transmitting a plurality of the indications of the status of the terminal and wherein the said indications are pushed from an indication server to the terminal. Alternatively, the method may comprise transmitting a plurality of the indications of the status of the terminal and wherein each said indication is transmitted from the indication server to the terminal in response to a respective request transmitted from the terminal to the indication server.

The method may comprise the step of, on determining that the service centre is ready to provide the terminal with the service, transmitting to the terminal an invitation to establish the session.

The invitation to establish the session may be transmitted in packet and/or SIP format.

The network demands may suitably include at least one of: bandwidth, reduced latency, reduced jitter and reduced delay. Preferably the second form of connection is a real-time connection. Most preferably the first form of connection is not a real-time connection.

The network may be a mobile telephone network. The network may be operable according to the GSM system or a derivative thereof, or the 3G or UMTS system or a derivative thereof.

The terminal is suitably a mobile telephone.

The present invention will now be described by way of example with reference to the accompanying drawings, in which:

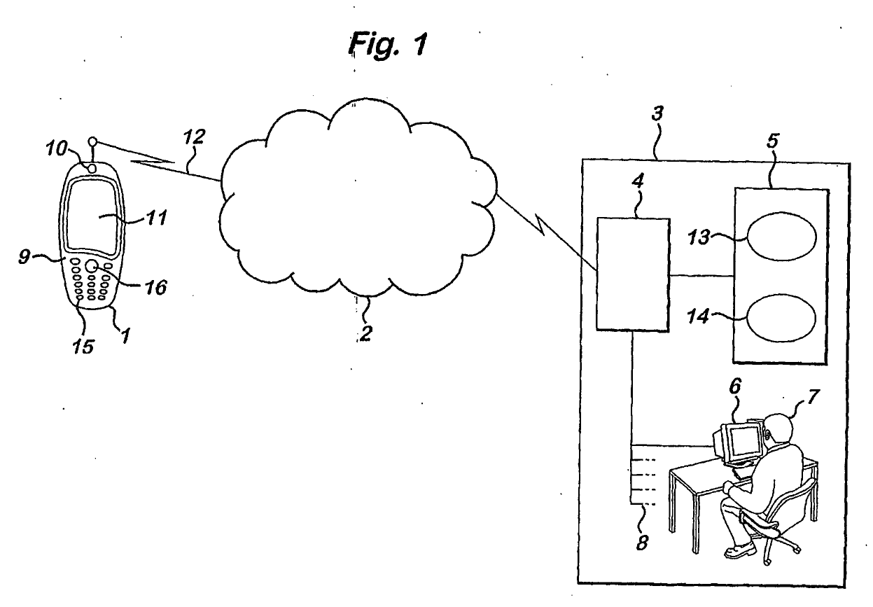

FIG. 1 illustrates the architecture of a communication system;

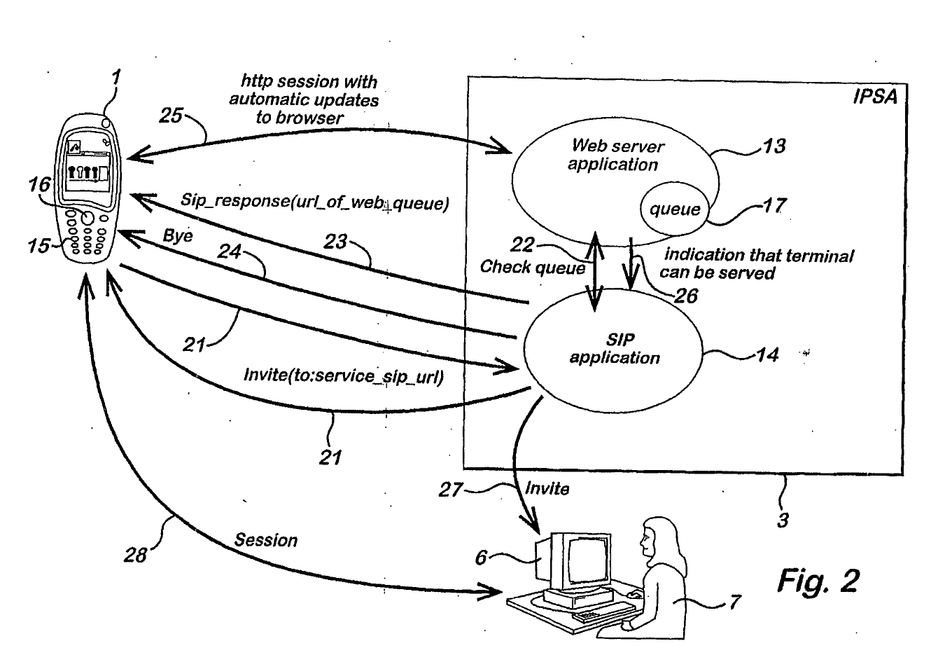

FIG. 2 illustrates communications paths; and

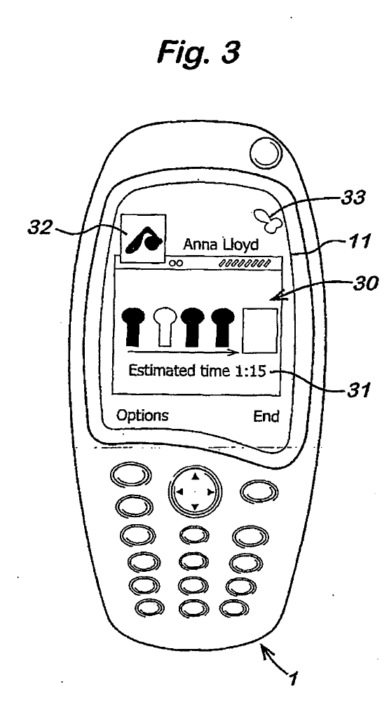

FIG. 3 shows an example of a terminal.

FIG. 1 shows a communication system in which a user terminal 1 is capable of communicating via a network 2 with a service centre 3. The service centre 3 is set up to provide a service to users of the communication system.

The network 2 may be a fixed or mobile communication network, such as a GSM network or a third generation (3G) UMTS (Universal Mobile Telecommunications System) network. Accordingly, the terminal 1 may be a fixed or mobile terminal such as a mobile phone.

The service centre 3 comprises a routing unit 4 for routing communications within the centre. Among the units to which the routing unit may route communications are a queuing control unit 5 and the terminal 6 of an agent 7. Links to other agents may be provided, as illustrated generally at 8. The agents may be human or automated.

The terminal 1 includes a microphone 9 and an earpiece 10 by means of which it can support a voice call in the normal way. In addition the terminal includes a display 11 which can be used to display messages received over a link to the network 2, as illustrated at 12. In this example, the terminal 1 is capable of supporting HTTP (hypertext transfer protocol) connections to other terminals acting as servers. Typically, HTTP connections are carried over packet-switched connections, which generally requires less bandwidth than a circuit-switched connection—especially for browser-type protocol transfers (e.g. HTTP) which generally make sporadic use of the connection.

The queuing control unit 5 of service centre 3 is implemented as an IPSA (internet protocol services aggregation) unit. This is conveniently implemented in the form of a general purpose processing unit with software for performing the necessary operations, but it could be implemented wholly in hardware. The IPSA includes a web server application 13 and a SIP (session initiation protocol) application 14. The web server application 13 and the SIP application 14 together provide the functionality to support the queuing of incoming calls and the provision of information to callers by on the expected wait in the queue.

The information on the expected wait is sent to callers' terminals by HTTP generated by the web server application 13. This means that until a caller reaches the front of the queue and begins a session with an agent the network does not need to provide a voice connection between the service centre 3 and the caller's terminal. Instead, the HTTP information from the service centre can be carried by a packet-switched connection, which typically consumes much less bandwidth than a voice connection.

The operation of the system will now be described in more detail.

Terminal 1 includes a browser 15 which is capable of interpreting browser instructions and interpreting them to present information to a user. Conveniently the instructions can be provided in visual form by means of display 11, but they could be interpreted in another way, for example by audible means. The browser instructions are preferably sent in the form of a mark-up language such as HTML (hypertext mark-up language)or XML (extensible mark-up language), suitably transferred using HTTP. The browser instructions are preferably sent as one or more self-contained pages or other blocks, each of which can be presented individually. In this way, the server 13 can communicate only sporadically with the terminal to provide the terminal with information on its status in the queue and thereby reduce the required bandwidth.

In the present example, the terminal 1 and the queuing control unit communicate using SIP. Other protocols could be used instead in other implementations. To support SIP the terminal 1 includes a SIP user agent 16. The SIP user agent is a data processing facility that supports the SIP protocol by interpreting SIP signals received from other terminals and generating SIP commands/responses for transmission.

Since in the present example the terminal uses HTTP and SIP, the applications present at the queuing control unit 5 are an HTTP (“web”) server application 13 and a SIP application 14. If other protocols were to be used then other applications could be provided at the server.

FIG. 2 shows the communication flow when the terminal 1 initiates a session with agent 7 at the service centre. For clarity, the network 2 is not shown in FIG. 2.

The user operates the terminal so as to request a session with an agent at the service centre. This causes the SIP user agent 16 to generate a SIP invite message indicating the address of the SIP application of the service centre. Typically the address will be in the form of a URL (uniform resource locator). The address of the SIP application of the service centre can be expressed as “service_sip_url”. The whole invite message can be expressed as:

Invite(service_sip_url)

This is shown as message 21 in FIG. 2.

Message 21 is routed by the network 2 (not shown in FIG. 2) to the service centre 3. At the service centre 3 the routing unit 4 recognises it as a message requesting specifying the address of the SIP application 14 and routes it to the SIP application.

The queuing control unit 5 manages the queuing of session requests at the service centre 3. For convenience, in the present example the queue is managed by the web application server 13, but another dedicated unit or application may be used instead. In the present application the web application server stores the queue on a data store 17.

When the message 21 requesting a new session is received at the SIP application 14 the SIP application queries the web application server 13 to check the state of the queue. This is illustrated as message(s) 22 in FIG. 2. If there is no queue—i.e. if an agent is currently free—the web application immediately sends message 25 (as described below) to cause the session to begin. If there is a queue then the web server adds the terminal to the queue and the SIP application sends to the terminal a SIP response indicating the URL of the web application server. The address of the web application server can be expressed as “url_of_web_queue”. The whole response can be expressed as:

Sip_response(url_of_web_queue)

This is shown as message 23 in FIG. 2.

Message 23 is routed by the network 2 to the terminal 1, where it is handled by the SIP user agent 16. In response to that message the SIP user agent causes the browser 15 to access the address URL specified in the bye message. The browser accesses that URL in the normal way and the web application server returns an HTML or XML page by HTTP. That page includes an indication of the status of the terminal in the queue. Preferably the page includes one or more of:

the position or rank of the terminal in the queue (see the iconic representation at 30 in FIG. 3)

the estimated time that the terminal will be in the queue (see time 31 in FIG. 3)

information about the service (see logo 32 in FIG. 3)

advertisements, the revenue from which could be offset against the cost of the service (see logo 33 in FIG. 3)

a browser form in which the user can fill in information relating to the service, for example his customer number or details of the service he needs

The web server may be providing similar pages to a number of terminals that are in the queue. To differentiate between the terminals so that each one is sent the relevant information the web server could use the terminals' addresses as they request a page by HTTP. Alternatively, the web server could have a set of virtual addresses and each queuing terminal could be given a different one of those addresses in the bye message it receives. FIG. 3 shows an example of a terminal 1 displaying a page from the web server on display 11.

The SIP application sends a Bye message 24 to the terminal

The HTTP session is illustrated as message(s) 25 in FIG. 2. The web server may update pages to the terminal at predetermined time intervals (e.g. every 10 seconds) to update the terminal on the expected wait in the queue. Alternatively, the information sent by the web server to the browser may include an indication that the browser should request a refreshed page after a predetermined time interval (e.g. every 10 seconds). The web server could transmit an applet, for example a Java applet using MExE, to the terminal. The applet could handle the requesting of page refreshes and, if desired, the initiation of a connection to the agent.

Each time an agent becomes available the web server allocates that agent to one of the queuing terminals on the basis of a predetermined algorithm. The algorithm may cause the agent to be allocated simply to the terminal that has been waiting the longest. Alternatively, some terminals may be given priority over others. One preferred approach is for the web server to analyse the browser form referred to above when it is returned by the terminal. If the information returned in the browser form indicates that the user of the terminal requires an expedited service then his terminal may be served as a priority, out of turn.

When the web server determines that a terminal (e.g. terminal 1) can be connected to an agent (e.g. agent 7) the web server transmits a message 26 to the SIP application 14 to inform it of the terminal that is now to be served and the address of the agent that is free. In response the SIP application uses SIP 3^{rd} party session set-up procedure to connect the terminal to the agent. This is shown as message 27 in FIG. 2.

In response to message 27 the terminal initiates a voice session with the agent at the attendant_sip_url address. This session is shown at 28 in FIG. 2. The terminal transmits a message to the attendant_sip_url address. This request is routed by the router 4 to the terminal 6 at the attendant_sip_url address and the session is started accordingly.

The session could be a circuit-switched session or a packet-switched session. In the above example the session was a voice session but it could be a session of another type, for example a data or video or mixed media session. The present invention is especially advantageous when the session is a real-time session (i.e. low delay) and the means used for message(s) 25 is a non-real-time link (i.e. one over which significant delay is tolerated), and/or when the session has reserved to it over network 2 significantly higher bandwidth than is reserved for the link carrying message(s) 25. When HTTP is used for messages 25 little if any bandwidth need be reserved for that link. The messages are preferably carried by a packet-switched connection, for example using internet protocol (IP).

Some examples of the services that can be provided by the service centre are: taxi ordering, banking, ticket reservations and directory enquiries.

It is preferred that the browser presents the information received from the web server in a visual form. This allows another disadvantage of prior art systems to be overcome. In prior art systems information on the terminal's status in the queue have been presented by the same means as is used for the session with the agent. When the session with the agent is to be a voice session the service centre has provided audible information to the user on the queue. This requires the user to listen continually to the information that is being provided, which is tedious if the queue is long. The system described above provides a way in which the queue information can be provided in a different medium from that used for the session. For example, the session may be a voice session but the queue information can be provided visually. This is less tedious for a user since he can get on with other things whilst the terminal shows how long he will be in the queue. The terminal may transmit an alert to the user when the session is to begin. The alert may be in the form of an audible alarm or an eye-catching pattern or animation on the display of the terminal. The terminal may be configured by the user to transmit such an alert.

The present invention may include any feature or combination of features disclosed herein either implicitly or explicitly or any generalisation thereof, irrespective of whether it relates to the presently claimed invention. In view of the foregoing description it will be evident to a person skilled in the art that various modifications may be made within the scope of the invention.

1-26. (Cancelled)

27. A method for providing a terminal with a service from a service centre, the terminal and the service centre being connected by a communication network, the method comprising:
transmitting from the terminal to the service centre a request for the service;
adding the terminal to a queue for the service;
transmitting from the terminal a request for one or more indications of the status of the terminal in the queue;
transmitting to the terminal by a first form of connection the one or more indications;
determining that the service centre is ready to provide the terminal with the service;
establishing a session between the terminal and the service centre using a second form of connection having greater network demands than the first form of connection; and
providing the terminal with the service using the session.

28. A method as claimed in claim 27, including the steps of:
receiving the request; and
determining whether the service centre is ready to provide the terminal with the service;
and wherein the steps of adding the terminal to a queue for the service and transmitting to the terminal by a first form of connection one or more indications of the status of the terminal in the queue are performed only if it is determined that the service centre is not ready to provide the terminal with the service.

29. A method as claimed in claim 27, wherein the request for the service is transmitted in a packet format.

30. A method as claimed in claim 27, wherein the request for the service is transmitted in SIP format.

31. A method as claimed in claim 27, comprising the steps of:
transmitting to the terminal an indication of the address of an indication server from which the one or more indications of the status of the terminal in the queue may be received; and
transmitting from the terminal to the said address a request for the one or more indications.

32. A method as claimed in claim 31, wherein the indication of the address of the indication server is transmitted in SIP format.

33. A method as claimed in claim 31, wherein the request for the one or more indications is transmitted in HTTP format.

34. A method as claimed in claim 27, wherein the said one or more indications are transmitted in a packet format.

35. A method as claimed in claim 27, wherein the said one or more indications are transmitted in HTML format.

36. A method as claimed in claim 27, wherein the said one or more indications include data in HTML format.

37. A method as claimed in claim 27, wherein the said one or more indications include an applet for execution at the terminal and the method includes the step of executing the applet.

38. A method as claimed in claim 27, comprising transmitting a plurality of the indications of the status of the terminal and wherein the said indications are pushed from an indication server to the terminal.

39. A method as claimed in claim 27, comprising transmitting a plurality of the indications of the status of the terminal and wherein each said indication is transmitted from the indication server to the terminal in response to a respective request transmitted from the terminal to the indication server.

40. A method as claimed in claim 27, comprising the step of, on determining that the service centre is ready to provide the terminal with the service, transmitting to the terminal an invitation to establish the session.

41. A method as claimed in claim 40, wherein the invitation to establish the session is transmitted in SIP format.

42. A method as claimed in claim 27, wherein the network demands include at least one of: bandwidth, reduced latency, reduced jitter and reduced delay.

43. A method as claimed in claim 27, wherein the second form of connection is a real-time connection.

44. A service provision system for providing a terminal with a service from a service centre, the terminal and the service centre being connected by a communication network, the service centre comprising:
a messaging arrangement capable of communicating with the terminal by means of a messaging protocol;
an indication server capable of receiving from the terminal a request for one or more indications of the status of the terminal in the queue and transmitting to the terminal by a first form of connection the one or more indications;
a data store for storing information defining the status of one or more terms in a queue for the service; and
an agent capable of providing the service to the terminal using a session between the terminal and the service centre using a second form of connection having greater network demands than the first form of connection;
and wherein the messaging arrangement is arranged to, in response to a request for the service from the terminal by means of the messaging protocol, determine whether the service centre is ready to provide the service and if it is not ready to provide the service to send a message indicating that it should request from the indication server an indication of the status of the terminal in the queue.

45. A method according to claim 27, wherein said terminal comprises a web browser for receiving information from said service centre in a visual form and for alerting the user of said terminal when the session is to begin.

46. A method according to claim 45, wherein the alert is in the form of an audible alarm.

47. A method according to claim 45, wherein the alert is an eye-catching animation on the display of said terminal.

48. A system for providing a terminal with a service from a service centre, the terminal and service centre being connected by a communications network and the service centre comprising:
a plurality of service agents, each for providing a directory enquiry service;
a routing unit for routing incoming requests for directory enquiry services from the terminal to the service agents; and
a queuing control unit for managing the queuing of said requests having a SIP application and a web application for storing the queue on a data store.

49. A method of communication using the system of claim 48, wherein a session is established between the terminal and least one of said service agents by performing the steps of:
i) the terminal sending a request for a new session to the service centre where it is routed by said routing unit to said corresponding SIP application;
ii) the SIP application querying the web application to check the status of the queue held in the data store;
iii) if a queue exists, the web application adding the terminal to the queue and the SIP application sending to the terminal response indicating the address of the web application; and
iv) the terminal acting on said response by accessing the corresponding web application using said address and retrieving an indication of the current status of the terminal in the queue;
v) when the web application determines a service agent is free, sending the address of said free agent to the SIP application; and
vi) said SIP application connecting the terminal to said free agent and the session being started.

50. A method according to claim 49, wherein said request in step i) is in the form of a SIP INVITE message.

51. A method according to claim 49, wherein the response in step ii) is the form of a SIP response and the address is the uniform resource locator (URL) of the web application.

52. A method according to claim 49, wherein if there is no queue after step ii) is performed the web application sends a message to cause the session to begin.
